(19) United States
(12) Patent Application Publication
(10) Pub. No.: US 2003/0193217 A1
(43) Pub. Date: Oct. 16, 2003

(54) Motor vehicle passenger compartment heat insulation and dissipation

(75) Inventor: Rolf Hesch, Lemgo (DE)

Correspondence Address: BROWDY AND NEIMARK, P.L.L.C., 624 NINTH STREET, NW, SUITE 300, WASHINGTON, DC, 20001-5303, US

(73) Assignee: MollerTech GmbH, Bielefeld (DE)

(21) Appl. No.: 10/435,027

(22) Filed: May 12, 2003

Related U.S. Application Data
(63) Continuation-in-part of application No. 09/242,340, filed on Feb. 12, 1999, now Pat. No. 6,561,562.
Application No. 09/242,340 is a 371 of international application No. PCT/DE97/01710, filed on Aug. 12, 1997.

(30) Foreign Application Priority Data
Aug. 13, 1996 (DE) 196 32 550.1

(51) Int. Cl. B62D 39/00

(52) U.S. Cl. 296/208

(57) ABSTRACT

A vehicle body part composed of: an outer skin forming a part of the outer surface of a vehicle; and an inner part disposed between the outer skin and the interior of the vehicle, the inner part performing a thermal insulation function, wherein the outer skin and the inner part enclose an air flow path through the body part adjacent the outer skin.

### CROSS-REFERENCE TO RELATED APPLICATION

This application is a Continuation-In-Part of pending U.S. application Ser. No. 09/242,340, filed Feb. 12, 1999, the disclosure of which is incorporated herein by reference.

### BACKGROUND OF THE INVENTION

Efforts are being made in the motor vehicle industry, in particular in connection with passenger cars, to reduce fuel consumption and pollution. One approach to this objective is to reduce the weight of vehicles.

Parallel with this, there is an ongoing effort to make vehicles safer, which often results in a weight increase because of additional components, for example the installation of transverse rails in the doors and struts in the vehicle cage. The resulting additional weight cannot even remotely be compensated by savings in the interior fittings.

Because of the trend toward smaller engines with improved efficiency, it becomes increasingly necessary to install auxiliary heaters, especially in vehicles of smaller size and medium size, because smaller engines and improved engine efficiency can result in insufficient waste heat for satisfactorily heating vehicle passenger compartments in cold weather.

In a further, parallel occurring development, it is becoming increasingly common to equip even smaller and medium sized vehicles with air conditioners as standard equipment.

Because of the increased employment of auxiliary heaters and air conditioners, gains that have resulted in reductions in fuel consumption and emissions, have been lost, or at least reduced.

On the average, air conditioners weigh 15 to 16 kg, i.e. by far more than can ever be saved in components of the interior fittings. Added to this is that operation of an air conditioner causes an average fuel increase of 0.6 l per 100 km. If an air conditioner is installed, both the weight savings at other places and the reduced consumption achieved thereby are completely or mostly lost. Driving comfort is increased, but consumption and environmental stress are increased.

Auxiliary fuel heaters weigh 2 to 4 kg on the average and consume 0.2 to 0.4 l of fuel per hour. Passive auxiliary heaters, which recover heat from the waste air of the passenger compartment by means of a heat pump, desorption heaters, and the like are limited in their output, most are heavier than auxiliary fuel heaters and because of the use of electric energy are neither more efficient nor, in particular, more ecologically beneficial.

Thus, parallel developments in the manufacture of passenger cars, each of which, when examined by itself, can be considered to be an improvement, as a whole can cancel each other partially out in regard to their ecological consequences.

From the viewpoint of ecology, the strong trend toward air conditioners in particular is a serious backward step. It leads to a considerable increase in fuel consumption and therefore to increased emissions of pollutants. This becomes clear, inter alia, from the recent demands, even from the automobile club sector, to require that manufacturers of vehicles openly disclose among the technical vehicle data the increase of fuel consumption as a result of the use of air conditioners, so that the buyer can clearly see what additional operating costs he or she will face in connection with air conditioners, and most of all what he or she has to pay for the luxury of an air conditioner with additional stresses on the environment.

U.S. Pat. No. 2,768,672 discloses a vehicle having partial thermal insulation, which consists of the attachment or connection of asbestos mats to surfaces of the interior bordering the exterior, and which is limited to this. The intended thermal insulation in this known solution has disadvantages, for example higher weight because of the asbestos mats, which neutralize at least a portion of the advantages of thermal insulation.

Thus, in the prior art, motor vehicles for carrying passengers are heat-insulated only in some regions if at all. Systematic, complete heat insulation is known only in refrigerator vehicles in which heat-sensitive goods are transported.

As an alternative or supplement to air conditioning systems, there are known systems, for instance made by Audi, that remove heat that has already penetrated into the passenger compartment while the vehicle was parked, again using the vehicle blower. Solar cells integrated into the sunroof, for example, furnish the energy required to do so.

Instead of comprehensive heat insulation and flushing out of the heat that penetrates the outer skin, air conditioners, which provide cooled air that absorbs the heat after it has entered the passenger compartment, are being built into vehicles. Air conditioners present the drawbacks already noted above.

Parent U.S. patent application Ser. No. 09/242,340 discloses the concept of insulating passenger-carrying vehicles as extensively as possible, in order to make air conditioners unnecessary, or at least to make it possible to use air conditioners of smaller capacity and thus with fewer drawbacks. According to that application, all of the parts of a vehicle forming its boundary with the outside, or at least those parts enclosing the passenger compartment, can be provided with insulating materials or molded insulating parts, in order to prevent the entry of heat into the vehicle interior in the summer and to prevent the loss of heat in winter.

### BRIEF SUMMARY OF THE INVENTION

The present invention achieves reduced energy consumption by, and therefore reduced emissions of pollutants from, motor vehicles, preferably in conjunction with the total insulation that is the subject of the parent application.

This is achieved in a manner to substantially reduce the energy required by conventional heating and air conditioning systems to maintain the passenger compartment at a comfortable temperature.

Improvements are achieved, according to the invention, by the provision of a an air flow path, formed by a venting gap or a venting conduit system, beneath the outer skin of one or more vehicle body parts, particularly those that enclose the passenger compartment, which skin is constituted by body panels that are usually made of sheet metal but may be made of other materials, such as plastic. The are flow path is disposed so that, particularly in hot weather, heat that has penetrated the outer skin can be conveyed back to the outside air, in order to suppress, or at least reduce, heat transfer to insulating and material layers, as well as to vehicle components, beneath the path and to thereby prevent storage of the heat by the aforementioned materials and/or components.

According to a further feature of the invention, the flow of air through the gap or vent may be halted in order to create a dead air space that provides additional thermal insulation. This would be particularly useful in cold weather to reduce demands on the vehicle heating system.

The present invention is preferably, but not necessarily, combined with intensive thermal insulation of vehicles, in particular those parts that enclose the passenger compartment, and adjacent areas of the vehicle in which thermal insulation is possible in accordance with their structure and function, for example trunks, cargo compartments, and the like, as disclosed in the parent application. Thermal insulation as referred to herein is to be understood to mean that portions of the vehicle which form parts of its exterior, such as doors, tops, floor components, door sills, pillars, transverse and longitudinal supports, trunk enclosures and the like, are to be provided with thermally insulating layers or thermally insulating molded parts as insulating bodies to the extent that this is constructively possible.

By means of this it is prevented that in summer heat can flow, scarcely stopped, into the interior, in particular into the passenger compartment which would, if air conditioning were to be installed, require a correspondingly large cooling capacity. The expense of thermal insulation is very much less than that for an air conditioner, and so is the weight. In contrast to an air conditioner, thermal insulation does not entail any operating costs, or, especially, polluting emissions.

As a rule, an effective thermal insulation will obviate the installation of air conditioners in vehicles in the lower and medium price range, or at least a much smaller installation will be sufficient. With vehicles that must have an air conditioner in spite of thermal insulation, an air conditioner with a fraction of the cooling capacity will be sufficient. Naturally, smaller air conditioners use up less energy and cause proportionally reduced polluting emissions. Also, weight is saved with them, which results in further energy savings.

Thermal insulation th reduces the penetration of heat in the summer also prevents the loss of heat in the winter. Vehicles can be kept warm in winter with a reduced use of energy. The amounts of waste heat, which become increasingly less, are then sufficient to heat the vehicles. Auxiliary heaters can be omitted to a large extent, or at least those with less heat output will be sufficient. In this case, too, weight as well as fuel is saved. Fuel is saved in a twofold manner, namely for the generation of heated air itself, as well as for carrying the increased weight of the auxiliary heater.

Thermal insulation can be provided to a large extent by the use of renewable raw materials. Therefore these should be preferably used. Renewable materials do not cause emissions, but the opposite instead. In the course of their assimilation, CO₂ already present in the air is reduced and oxygen is released. All possibilities of insulating material, or respectively insulating body designs, can be used by the combination with binding agents and foams made from synthetic plastic materials, derivations of natural materials and/or biogenous materials.

Effective thermal insulation also automatically results in an important addition to improved traffic safety: as determined by a study by TÜV [Technical Inspection Service], a temperature increase in the vehicle from 25° C. to 35° C. reduces the fitness of a driver in traffic to the same degree as a blood alcohol content of 0.5 per thousand.

Combined with reinforcement and/or planking elements, for example made of sheet metal, the insulation bodies can also result in considerable mechanical protection and can completely or partially replace the metal rails, which of late have been installed in vehicle doors for improving side impact protection. The omission of the rails also saves weight. Thus, the replacement of the rails by rigid and energy-dissipating thermal insulation elements, together with the outside and inside sheet metal panels of doors, can take place without significant weight increase. A weight reduction might possibly be conceivable; a complete foam filling of, for example, vehicle doors for the purpose of thermal insulation already demonstrably increases the moment of resistance of the door considerably in comparison with a hollow door as is constructed in accordance with the prior art. In the course of tests, the reinforcement of the thermal insulating foams by fibers, yarns, stalks, non-wovens, fabrics and similar structures, preferably made of renewable raw materials, has resulted in a further considerable increase in strength. Even when reducing the sheet metal thickness by half, it was possible to achieve strength values that lay far above those in accordance with the prior art, and this even with a reduced total weight.

Thermal insulation as described herein with additional reinforcement steps also achieves safety functions in a dual manner: even without air conditioners, or with low cooling capacities, it is possible to maintain the interior climate of vehicles in ranges that are helpful to the driving fitness of the driver. In the case of a crash, a vehicle provided with thermal insulation in the described manner offers great sturdiness and a large ability for absorbing impact energy. These thermal damping elements also do not splinter into sharp edges.

Further advantages of the thermal insulating elements reside in acoustic insulation. A low noise level in the vehicle, besides a pleasant temperature, is a further prerequisite for a very good driving fitness of the driver. He does not get tired as quickly and is less stressed by nerves. Already, some vehicle manufacturers reduce the interior noise generation in particularly critical zones by means of felt. Separate acoustic insulation measures are superfluous in an intensely thermally insulated vehicle, since thermal insulation designed in this manner also increases acoustic insulation as an intentional or unintentional side effect.

Thermal insulation measures taken in accordance with the invention disclosed in the parent application permit a reduction of the thickness of the body sheet metal without loss in strength, especially if the thermal insulation elements are fixedly connected with the body sheet metal, for example by foaming or adhesion. Insulating elements, in particular those reinforced in the described manner, can partially assume supporting functions in the place of sheet metal—a considerable contribution to easier recycling and better ecology.

Besides the above mentioned tendencies, which are counterproductive from an ecological point of view, developments in vehicle construction also include a tendency toward “vehicle modules”. For example, in the future a door should no longer be delivered in many individual parts by different suppliers to the passenger car manufacturer and only be assembled there, but should be delivered completely as a “module”, so that it need only be hung. Thermal insulation elements produced in the described manner can, if they are reinforced in accordance with the invention, take on the functions of a support of functional elements, for example window lifts, door locks, etc., in addition to thermal insulation and accident protection, and with a decorative interior can replace the interior panel of the old style as a decorative single purpose element, so that to this extent the solution described above also takes this development into account.

### BRIEF DESCRIPTION OF THE DRAWINGS

FIG. 1 is a longitudinal cross-sectional view through a motor vehicle body with areas of thermal insulation and a flow passage according to the invention.

FIG. 2A is a divided elevational cross-sectional view of a vehicle as disclosed in the parent application, the left side being taken in a plane corresponding to plane A-A and the right side being taken in a plane corresponding to the plane A′-A′ of FIG. 1.

FIG. 2B is a cross-sectional view similar to that of FIG. 2A of a vehicle having a roof constructed according to the invention.

FIG. 3 is an elevational cross-sectional view through a motor vehicle door with thermal insulation and an air flow path in accordance with the invention.

FIGS. 4A and 4B are two cross-sectional views through a motor vehicle roof with air flow paths according to the invention.

FIG. 5 is a partly schematic plan view of a vehicle roof having the air flow path of FIG. 4B.

### DETAILED DESCRIPTION OF THE INVENTION

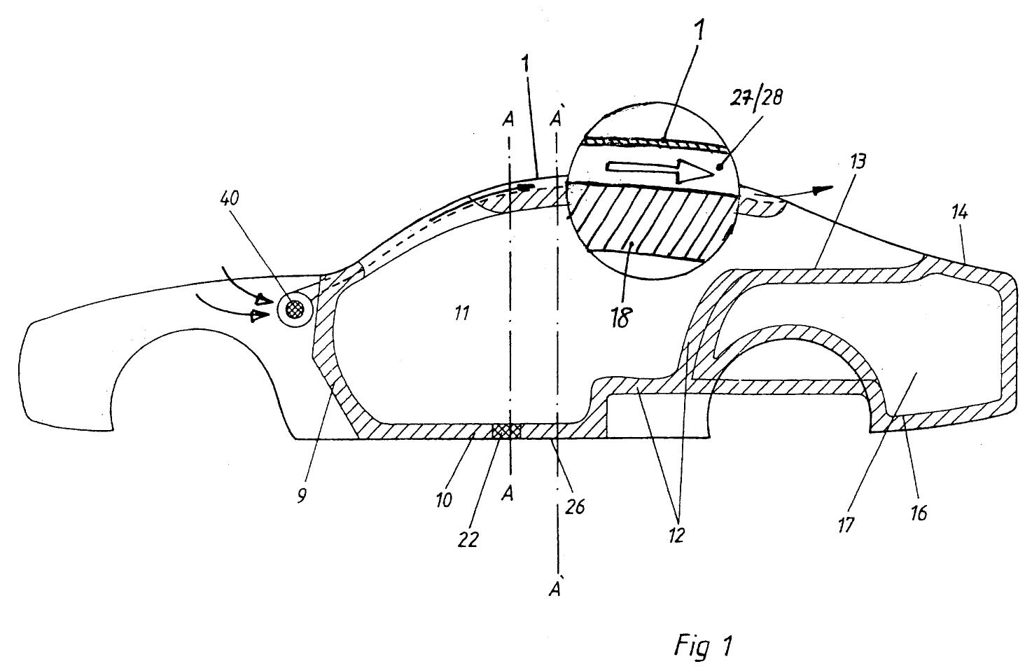

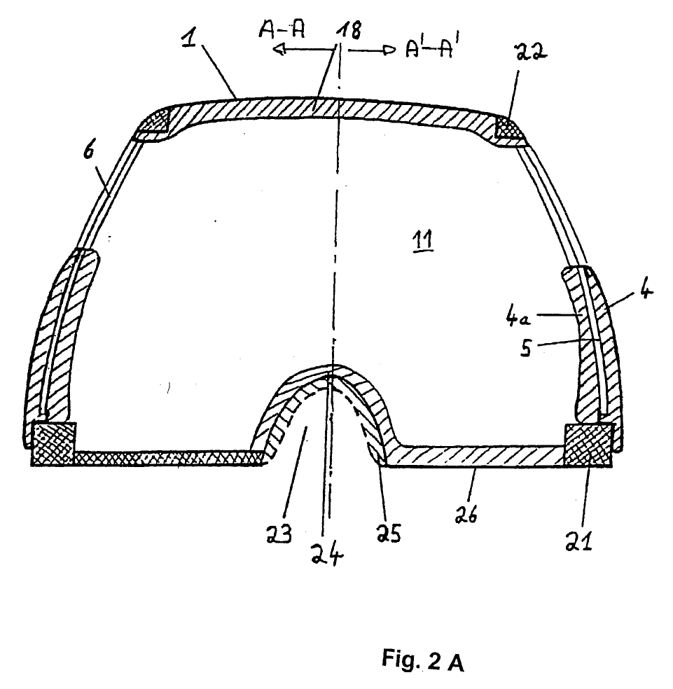

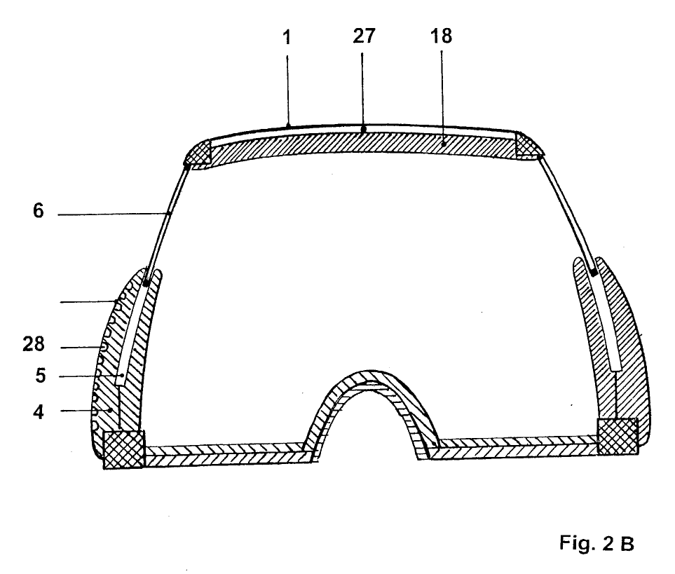

FIGS. 1, 2A and 2B show the essential structural areas of a motor vehicle that can be provided with thermal insulation as described in the parent application. The shaded areas in FIG. 1 represent the built-in insulating layers and molded insulating parts.

In this connection it is basic that, depending on the functions and specific loads on each one of these areas, it is possible to select a thermal insulation, either as an insulating body of a preselected shape, or as a thermal insulating material whose shape is only created during or after its application on an associated component, for example by foam application/heating which, because of its further properties, even complements and improves the basic function of the associated component. Thus, novel functioning units with qualitatively improved properties, not only in respect to the desired thermal insulation, but also in respect to mechanical strength, acoustic insulation, weight reduction, etc. are created by means of the integration of the respective thermal insulating material.

There are often hollow spaces in a vehicle body part, located between an inner part and the outer skin 1, examples of this to be mentioned here are the rails 22, door sills 21, and the area between the inner and outer wheel well. According to one feature of the invention, these rails and sills may be filled with insulation material to provide further insulation improvements.

Here, thermal insulation is ideally achieved by foam application. Only a small opening in the respective hollow space is needed for inserting the insulating material in liquid form. Curing, or respectively polymerization, of the plastic material used, for example polyurethane, only takes place after this. With many plastic materials, the start of foaming can be initiated from the outside, for example by first placing unfoamed contoured pieces into the hollow space, which are then caused to foam up by the effects of heat.

Insulating material is selected in the area of the instrument panel, the fire wall and the floor 9 which, besides good thermal insulation properties, also has resilient and/or shock-absorbing properties, in order to reduce the danger of head or knee injuries in particular to the driver and front seat passenger in case of an accident.

While mostly rigid preformed elements are provided as insulating bodies for thermal insulation in the area of the instrument panel, in the area underneath the instrument panel and/or fire wall 9, foam application of a thermal insulating material or gluing-on of resilient insulating mats are also conceivable. In any case, it is important that the insulating material is fixedly connected with the sheet metal in front of it, for example is glued to it. Only in this way is it possible to achieve optimal energy dissipation in case of an impact.

In this area 9, which borders the engine compartment, the thermal insulation can also provide a contribution to acoustic insulation, for example by a suitable profiling (egg carton profile) toward the engine compartment.

In the floor area 10, a material, for example a composite material, has been selected for thermal insulation, which has a hard surface capable of resistance, since this area is greatly mechanically stressed, particularly by entrance and exit of the driver and passengers.

If the rear area 12 of the passenger compartment is to be thermally insulated from the trunk 17, it is recommended to integrate a suitable insulating body in the seat and/or the seat back. This can be done in such a way that panels made of a thermal insulation material, for example a composite of natural fibers or also styrofoam, are worked into the seat and/or seat back 12, or that the seat and/or seat back 12 are made of self-supporting, insulating preformed insulating elements.

The rear window shelf 13 is preferably produced as a self-supporting plastic or expanded rigid polyurethane element of sufficient thickness. Although such components have already been made of expanded foam and composite materials, this was done in view of the weight savings that could be achieved by this along with sufficient stability. The thermal insulating effect achieved by means of this is therefore negligible in actual use, in particular because of the too small portion of these surfaces on the outer surface of the passenger compartment.

In the area of the underbody 26 and the transmission tunnel 23, a thermal insulation 25 is also provided on the outside besides the thermal insulation 24 on the inside. This can be achieved, for example, by foaming impact-resistant plastic onto the entire underbody group. The application of one or several preformed elements is also conceivable. In addition to thermal insulation, protection of the underbody 26 against salt, thrown rocks, etc. is also achieved. In case preformed elements are used for thermal insulation, it is conceivable to make them in the form of easily replaceable “wear elements” because of the high mechanical stresses to which they are exposed. In this case care should be taken in particular that a good recycling ability of the used insulating material is provided.

For thermal insulation of the areas 14 bordering the trunk 17, preformed elements made of a hard plastic are provided. For example, the trunk lid can be insulated by means of an insulating body made of foam material.

In vans, station wagons and similar types of motor vehicles, the cargo compartment takes the place of the trunk and can be correspondingly included in the total insulating measures. The importance of the trunk, or respectively of the cargo compartment, for thermal insulation lies in an “enlargement” of the passenger compartment by including this volume in the ventilating and/or air conditioning system of the motor vehicle, because of which the oxygen supply can be increased, the supply of exterior air reduced and in this way the thermal insulation balance improved.

Particular importance is placed on the insulation of the roof area 18, since it is particularly strongly heated by the sun in summer. To this end it is provided to make the headliner of a plastic material having a particularly high thermal insulation value. Here, too, solutions using expanded foam or composite materials are known, however, as mentioned above in connection with the rear window shelf, without a noticeable thermal insulating effect of the total system known as the “passenger compartment”.

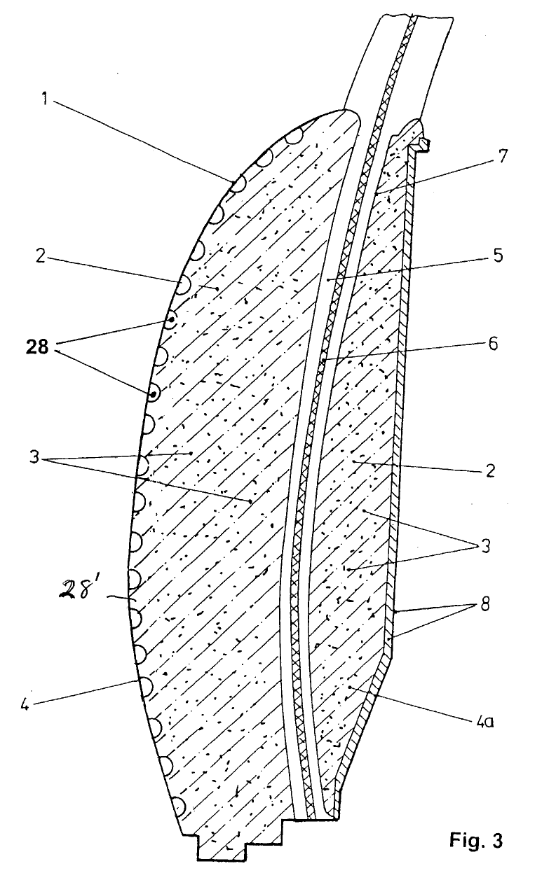

Since the vehicle roof, which in most cases has a sheet metal skin, can heat up very strongly, in particular when traveling slowly or when in a traffic jam, it is furthermore provided to arrange a an air flow path, or ventilating system, formed, for example, by a ventilation gap 27, or a system of passive ventilating elements, such as ventilation channels 28, for example, which communicate with the outside, between the thermal insulation and the inside of the sheet metal of the roof. By means of this it is possible to transport heat convectively to the outside. In this case convection can be aided by passing the slip stream through or by using a separate ventilation. Such an interior ventilation can of course also be employed in other vehicle areas, such as in a door as shown in FIG. 3. For the area of the roof in particular, such passive ventilation can also be aided by active ventilating elements. In this case it is possible, for example, to use blowers, which can also be operated by solar cells that can be housed in the roof or the bumpers.

Thermal insulation of the door is provided in two parts in the illustrated exemplary embodiment shown in FIGS. 2A and 2B. An outer preformed body 4 is connected with the inside of the exterior sheet metal 1. Since, as a second effect, besides the thermal insulation, an increase in the rigidity and the energy dissipation capability during deformation (side impact protection) is also intended, two measures have been taken: for one, the preformed body is connected, at least at spaced points, over its entire surface with the inside of the exterior sheet metal, for example glued to it, and then reinforcements 3, for example high-strength plastic fibers, have been worked into the preformed body 4.

An inner preformed body 4a (FIG. 2A) is located on the inside of the door. A hollow space 5 for receiving the window 6 is located between the two preformed bodies. The inner preformed body 4a supports the required function and handling elements, such as guide and lifting elements for the window 6, door closing apparatus, and the like. Decorative elements 8 are provided on the side of the preformed body 4a facing the interior. Furthermore, holders for loudspeakers and channels for cables are provided. The inner preformed body also aids in the stiffening of the door, for which reinforcements 3 have also been provided inside the preformed body 4a.

Inner preformed body 4a takes on a total of four tasks: thermal insulation; increasing mechanical stability; as a component support; and as interior decoration, and therefore represents a special example for the possibilities of thermal insulation.

All insulating measures decribed above can of course also be employed if the body or parts thereof have been made of plastic.

The following will focus on the air flow spaces that characterize the present invention.

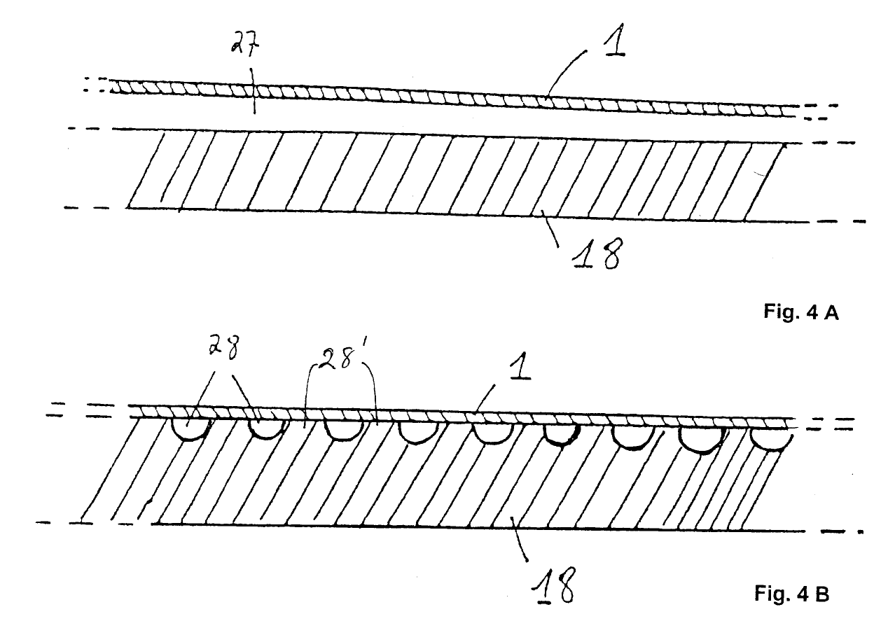

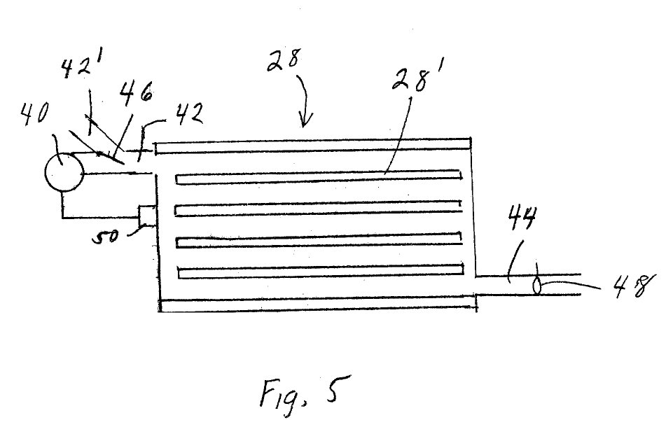

FIG. 1 shows one example of a ventilating system according to the invention in the roof between the outer skin 1, which is usually made of sheet metal, and the molded insulating part 18, which may also form the headliner. The ventilating system can be embodied either as a venting gap 27, as also shown in FIGS. 2B and 4A, or as a venting conduit system 28, as also shown in FIGS. 4B and 5.

As already noted at the outset, the function of the ventilating system is to create an air flow that immediately removes heat that has penetrated the outer skin 1 by blowing it out of the gap or conduit system and thus conveying it away from vehicle to the environment. Thus, the ventilating system ideally does not give heat an opportunity to penetrate the insulating part 18 and enter the passenger compartment.

When the vehicle is being driven, the ventilating system can be operated passively, because the dynamic pressure of the air moving past the vehicle will flow into inlet openings in the front part of the vehicle, through the venting gap 27 or the venting conduit system 28, and then out through outlet openings at the rear part of the vehicle. This air flow flushes out the heat that has penetrated outer skin 1.

The inlet openings, which can be, regulated and closed, are not shown in FIG. 1, but are shown schematically in FIG. 5. Depending on engineering and design requirements, these openings can be accommodated at any arbitrary point in the engine compartment, in or above the hood, in the A-pillars, or at the transition from the windshield to the roof.

When the vehicle is stopped, or moving slowly, no dynamic pressure for passive ventilation is available. In that case, active ventilation elements must be available. These may primarily comprise a blower 40, which in FIG. 1 is shown as a positive pressure blower in the front region of the vehicle. Blower 40 can be the blower of the vehicle climate control system or can be an auxiliary blower. Air can be forced through a passage provided in one or each A-pillar into the ventilation path 27/28, for instance in the roof. However, a suction blower can for instance be accommodated in the trunk, or at some other point, in place of or in addition to blower 40 to aspirate the air from ventilation path 27/28 and expel the heated air to the ambient air via outlet passages in, for example, the C-pillars. It is also technologically feasible to use cross-flow blowers directly at the transition from the roof to the rear window, to avoid having to carry the heated air through the C-pillars. The energy for operating the blower in the parking mode could be furnished by solar cells directly, or by batteries.

While driving slowly or in a traffic jam, it should be possible as needed to switch over to the blower, which can draw its energy from the vehicle engine.

When the inlet and outlet openings of the ventilation path 27/28 are closed in winter, a layer of dead air is created between the outer skin 1 and the various insulating bodies 18, 4, and others, thus providing one additional insulating layer against the cold.

FIG. 2A shows the cross section of a heat-insulated passenger car in the version according to U.S. application Ser. No. 09/242,340, without ventilation elements 27/28 in the roof and doors.

FIG. 2B shows the same vehicle cross section as FIG. 2A, but with a venting gap 27 in the roof and a venting conduit system 28 in one of the doors, although either a gap 27 or a conduit system 28 could be provided in each of the doors. Since the roof as a rule does not support a load, venting gap 27 can extend over its full width, as shown. Such a gap 27 offers a larger open cross section and a lower wall/air friction than the venting conduit system 28 and is therefore especially well suited to assure intensive heat dissipation in the region of the roof, which after all is what is most severely exposed to the sun.

For the doors, conversely, in the example shown, recourse has been made to the venting conduit system 28. The exposure of the doors to the sun is less than for the roof, so that a cooling and flushing air course that is not so large and not as free of friction is not a substantial disadvantage. Instead, the system with venting conduits 28 makes it possible for the outer skin 1, via webs, or bridges, 28′ shown in FIGS. 2B, 3 and 4B between individual venting conduits 28, to be adhesively bonded over its full surface to molded insulating body 4 to make a composite molded part. This offers several times the rigidity of a construction with gap 27, in which because of the continuous ventilation gap, the outer skin 1 and insulating body 18 cannot be adhesively bonded to one another. The outer door element 4, in combination with the outer skin 1 adhesively bonded to one another over the full surface, or welded or otherwise firmly joined, results in a composite material of very high strength and high-quality heat insulation and high-quality side-impact protection at the same time.

FIG. 3 shows, in greater detail, a motor vehicle door that provides both heat insulation and side-impact protection simultaneously. The door is composed of outer skin 1, usually of sheet metal; foam insulating materials 2 that provide heat insulation and that may contain embedded fibers 3 or the like that provide mechanical reinforcement and a high bending strength. Insulating materials 2 with embedded fibers 3 form fiber-reinforced molded bodies 4 and 4a that act as heat insulators. Body 4, by its firm bond with the outer skin 1, also offers side-impact protection.

FIG. 4A shows in detail a ventilation gap 27, extending over the full width of the roof, between outer skin 1 and molded insulating part 18, as one of many possible exemplary embodiments.

FIG. 4B shows a sealed conduit system 28. Via the webs 28′, a firm connection between molded body 18 and outer skin 1 can be produced in the manner described, which would lead to great strength of the roof or other vehicle parts. Conversely, the cooling effect would be less than in the case of FIG. 4A, since the open cross section of the conduit system 28 is less than that of the cooling gap 27, and the wall friction with the air is greater.

FIG. 5 is a simplified pictorial plan view of one embodiment of the elements forming an air flow path in the roof of a vehicle according to the invention. This embodiment is constituted by a conduit system 28 providing a plurality of channels that are separated by webs 28′ that extend between the outer skin and the inner part of the roof. The channels extend in the direction of the length of the vehicle. At the front of the roof, the conduit system is provided with an air inlet channel 42, while at the rear of the conduit system there is provided an air outlet channel 44. Inlet channel 42 includes a bypass duct 42′.

A blower 40 is disposed at the inlet end of channel 24 and a pivotal door, or valve, 46 is mounted at the junction of channel 42 and duct 42′ and is movable between a position for blocking duct 42′ and a position for blocking the output of blower 40. Outlet channel 44 is provided with a door, or valve, 48 that is movable between a position for opening channel 44 and a position for blocking channel 44.

Blower 40 may be the blower of the vehicle heating system, or may be an auxiliary device provided for supplying air only to the air flow path. In the latter case, blower 40 may be powered by current supplied from a photovoltaic solar cell system 50 mounted on the vehicle roof.

Preferably, air in channel 42 and duct 42′ may be provided within an A-pillar of the vehicle, and channel 44 may be provided in a C-pillar of the vehicle. Inlet channel 42 may open under the hood of the vehicle, while duct 42′ opens to the outside either above the vehicle hood or at the vehicle fender. Channel 44 may open at a location above the vehicle trunk. As illustrated, it would be preferable for inlet channel 42 to be located at one side of the vehicle and channel 44 to be located at the opposite side to promote a uniform air flow across the width of the roof.

When the vehicle is in motion, blower 40 may be turned off and door 46 moved to a position to unblock duct 42′, while door 48 is moved to its open position. Then, the motion of the car will produce an air flow through duct 42′, the channels of system 28 and outlet channel 44 to carry off heat in hot weather. When, in hot weather, the vehicle is stationary, door 46 will be moved to a position to block duct 42′, door 48 will be in the open position and blower 40 will be turned on the produce a flow of forced air through the conduit system.

In cold weather, door 46 can be moved to the position to block duct 42′, blower 40 can be turned off, thereby blocking any flow of air through duct 42 and, if desired, door 48 can be moved to the closed position. As a result, a dead air space will be formed within the conduit system to provide an additional layer of insulation.

Of course, as already described above, conduit system 28 could preferably be replaced by venting gap 27, which would be configured to extend essentially across the entire width of the roof.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A vehicle body part comprising:
an outer skin forming a part of the outer surface of a vehicle; and
an inner part disposed between said outer skin and the interior of the vehicle, said inner part performing a thermal insulation function,
wherein said outer skin and said inner part enclose an air flow path through said body part adjacent said outer skin.

2. The body part of claim 1, having a front end and a rear end, wherein said air flow path has an air inlet at said front end and an air outlet at said rear end, and said air path supports a flow of air between said inlet and said outlet while preventing the air flow from passing through said inner part.

3. The body part of claim 2 wherein said air flow path is constituted by a gap or a plurality of channels.

4. The body part of claim 3, further comprising an air propelling device disposed for producing an air flow though said air flow path.

5. The body part of claim 4, further comprising flow blocking means disposed for blocking air flow through said air flow path.

6. The body part of claim 5 wherein said flow blocking means comprise at least one flow blocking element in at least one of said air inlet and said air outlet.

7. The body part of claim 7 wherein said at least one flow blocking element comprises an inlet flow blocking element in said air inlet and an outlet flow blocking element in said air outlet.

8. The body part of claim 4 further comprising solar cells connected for supplying operating power to said blower.

9. An automotive vehicle having a plurality of body parts, wherein at least one of said body parts is the body part defined in claim 1.

10. The automotive vehicle of claim 9 wherein said at least one of said body parts is a vehicle roof.

11. The automotive vehicle of claim 9, said vehicle having a heating system that includes an air blower, wherein said air blower is coupled to said air flow path to produce an air flow along said path.

12. The automotive vehicle of claim 11, further comprising flow blocking means disposed for blocking air flow through said air flow path.

13. The automotive vehicle of claim 9, further comprising flow blocking means disposed for blocking air flow through said air flow path.

14. An automotive vehicle having a plurality of body parts, wherein two of said body parts are a roof and a door and each of said roof and said door is a body part defined in claim 1.
